(19) United States
(12) Patent Application Publication
(10) Pub. No.: US 2008/0129208 A1
(43) Pub. Date: Jun. 5, 2008

(54) Atmospheric Processing Using Microwave-Generated Plasmas

(76) Inventors: Satyendra Kumar, Troy, MI (US); Devendra Kumar, Rochester Hills, MI (US); Mike L. Dougherty, Rochester Hills, MI (US); Kuruvilla Cherian, Rochester Hills, MI (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/667,180

(22) PCT Filed: Nov. 1, 2005
(86) PCT No.: PCT/US05/39642

§ 371 Date: Oct. 19, 2007

Related U.S. Application Data
(60) Provisional application No. 60/625,236, filed on Nov. 5, 2004.
(60) Provisional application No. 60/625,433, filed on Nov. 5, 2004.
(60) Provisional application No. 60/625,502, filed on Nov. 5, 2004.

(51) Int. Cl. H05H 1/46; B23K 9/00; B23K 1/012

(52) U.S. Cl. 315/111.21; 219/121.36

(57) ABSTRACT

An atmospheric plasma processing system is presented. In accordance with embodiments of the present invention, an atmospheric pressure plasma microwave processing apparatus includes a processing area or chamber wherein parts are processed; at least one multi-mode microwave reactor coupled to receive parts for processing; at least one magnetron coupled to at least one multi-mode microwave reactor to provide microwave energy; and a delivery system coupled to at least one multi-mode microwave reactor to deliver the parts into and out of at least one reactor, wherein a plasma can be generated at atmospheric pressure and provided to the parts in at least one multi-mode microwave reactor.

### RELATED APPLICATIONS

The present invention claims priority to the following U.S. Provisional Patent Applications, each of which is herein incorporated by reference in its entirety:
U.S. Provisional Patent Application No. 60/625,236 titled Efficient Brazing with Microwaves, filed on Nov. 5, 2004, by Devendra Kumar et al.
U.S. Provisional Patent Application No. 60/625,502 titled Atmospheric Pressure Plasma Microwave Processing, filed on Nov. 5, 2004, by Mike Dougherty, Sr. et al.
U.S. Provisional Patent Application No. 60/625,433 titled Carburization of Steel Alloys by Microwave Plasma at Atmospheric Pressure, filed on Nov. 5, 2004, by S. Kumar et al.

### BACKGROUND

1. Field of the Invention

This invention is related to microwave processing and, in particular, to atmospheric pressure plasma microwave processing. Specific embodiments of the invention include efficient brazing of materials with microwaves, and carburization of steel alloys by microwave plasma at atmospheric pressure.

2. Discussion of Related Art

Heat treatment processing is often utilized in manufacture of parts and assemblies. For example, brazing or welding of two metallic pieces involves heating the two pieces to a temperature such that a material can be melted and flowed between the two pieces. The two pieces are bonded when the brazing material cools.

Another process that involves heat treatment is carburization of metallic parts. Carburization is a surface hardening technique that involves deposition and diffusion of carbon into the surface of the part. The process generally involves heating the part in a carbon-rich environment.

Other manufacturing processes that involve heating of parts include sintering, crystallization and decrystallization techniques, and other processes.

Conventional heat treatment processes typically require furnaces with large thermal masses in order to conduct and radiate the heat to parts being treated. In general, these furnaces require very large amounts of energy and are not easily controllable for fast heating and cooling of parts.

Some manufacturing processes have utilized microwaves. However, microwaves are easily reflected by metals. At room temperature the “skin depth,” a measure of the penetration depth of the radiation inside the metal, is very small (see equation 1).

Skin depth=(πσfμμ₀)^{-1/2} (1)

### Where

σ=conductivity of metal,

f=frequency of electromagnetic field,

μ₀=permeability of free space, and

μ=magnetic permeability of the medium.

At 2.45 GHz, the most commonly used microwave frequency for industrial applications, the skin depth at room temperature for copper is ˜4 microns and for steel ˜10 microns. The skin depth varies inversely as the square root of the frequency—i.e., as the frequency rises, the skin depth decreases. The boundary conditions also require that practically no microwave energy be absorbed even within the skin depth. Consequently, most of the microwave energy is reflected from the surface of a metal. Microwaves, therefore, cannot be used for direct, efficient heating of metals.

Some indirect methods have been used in the past for microwave heating of metals. These are based on the use of ‘susceptors’ that absorb the microwave energy and, subsequently, pass on the resulting heat to the target metal. This method does allow microwaves to heat metals but it is exceedingly slow and highly inefficient. The dielectric constant of a susceptor is complex and can be expressed as

∈=∈′−j∈″ (2)

### The loss tangent, which is a measure of the energy loss in the susceptor, is given by

Tan δ=∈″(ω)/∈′(ω) (3)

The loss tangent for most of the traditionally used susceptors (e.g., Alumina, SiC, etc.) at room temperature is very small (˜0.01-0.02) but it increases with temperature. See A. C. Metaxas, “Foundations of Electroheat—A Unified Approach,” John Wiley & Sons Ltd., Chichester, UK, 1996, and R. C. Metaxas and R. J. Meredith, “Industrial Microwave Heating,” IEE Power Engineering Series 4, A. T. Johns, G. Ratcliff and J. R. Platts, Series Eds., Peter Peregrinus Ltd., London, UK, 1993. Consequently, the initial heating rates are quite small and most of the microwave energy is simply wasted. As an example, it is not uncommon to achieve ˜1000° C. temperature in 20-30 minutes with a nominal microwave power of 1-2 KW. The heat transfer from susceptor to the target metal piece again introduces losses and further slows down the process.

Some new ceramics (e.g., zirconia) are much better absorbers of microwaves, but suffer from the characteristic of heating ‘inside out,’ i.e., having a higher temperature inside than outside. An additional problem with the use of such susceptors is the fact that they are prone to localized overheating due to the microwave coupling characteristics that inherently promotes thermal runaway.

The production of plasma provides an alternative method for heating metals with microwaves. Plasma contains free electrons and ions that can couple very well with the microwave radiation to induce good absorption. Traditionally, however, plasma has been used at reduced pressures where it is much easier to excite. This approach not only necessitates the use of expensive vacuum systems but also slows down the process time. In some recent experiments, microwave plasma is initially ignited in a gas at a reduced pressure. The pressure is then raised to the atmospheric pressure for actual processing. See I. Dani, V. Hopfe, D. Rogler, L. Roch, G. Mader, “Plasma Enhanced CVD at Atmospheric Pressure for Wide Area Coating on Temperature Sensitive Materials,” Ninth International conference on Plasma Surface Engineering, Garmisch-Partenkirchen, Germany, Sep. 13-17, 2004. This is possible because, once ignited at a reduced pressure, the microwave plasma can continue to sustain itself when the pressure is raised. However, this technique does not increase the speed of processing.

Previous attempts to create and sustain plasma at atmospheric pressure have met with limited success in terms of their efficiency and the range of utility. The two commonly used methods are based on the corona/glow discharge and the dielectric barrier discharge. These are generally excited by DC, pulsed DC or RF currents and do not have the ability to heat the target sample in a fast and efficient manner or, otherwise, can be limited to a very small plasma volume. See papers presented at the “Atmospheric Pressure processes” Sessions at the Ninth International conference on Plasma Surface Engineering, Garmisch-Partenkirchen, Germany, Sep. 13-17, 2004, and H. Schlemm and D. Roth, “Radio-frequency atmospheric pressure plasmas—a new basic approach for plasma processing,” GALVANOTECHNIK, Special Edition, Issue 6, Vol. 92 (2001).

Therefore, there is a need for processes and apparatus utilizing plasmas at atmospheric pressure, including embodiments that provide carburization and microwave brazing.

### SUMMARY OF THE INVENTION

In accordance with the invention, an atmospheric pressure plasma microwave processing apparatus is provided. A processing apparatus according to some embodiments of the present invention can include at least one multi-mode microwave reactor coupled to receive parts for processing; at least one magnetron coupled to each of the at least one reactor to provide microwave energy; and a delivery system coupled to the at least one multi-mode microwave reactor to deliver the parts into and out of the at least one multi-mode microwave reactor, wherein a plasma can be generated at atmospheric pressure and provided to the parts in each of the at least one multi-mode microwave reactor.

An atmospheric pressure plasma microwave processing apparatus according to some embodiments of the present invention includes a processing area or chamber wherein parts are processed; at least one multi-mode microwave reactor coupled to receive parts for processing; at least one magnetron coupled to at least one multi-mode microwave reactor to provide microwave energy; and a delivery system coupled to at least one multi-mode microwave reactor to deliver the parts into and out of at least one reactor, wherein a plasma can be generated at atmospheric pressure and provided to the parts in at least one multi-mode microwave reactor. In some embodiments, a plurality of magnetrons are utilized. IN some embodiments, the delivery system includes a conveyor belt. In some embodiments, the delivery system includes a rotating table system. In some embodiments, the parts are contained within a cavity. In some embodiments, the at least one multi-mode microwave reactor includes a plurality of multi-mode microwave reactors. In some embodiments, the delivery system includes at least one cooling pod area for holding parts in the system after processing.

In some embodiments, the at least one multi-mode microwave reactor includes at least one hexagonally-shaped reactor. In some embodiments, the processing area or chamber is sealed, and the delivery system includes an airlock through which parts pass into the processing area or chamber. In some embodiments, the containment material is composed partially or completely of a ceramic. In some embodiments, the containment material is composed partially or completely of quartz. In some embodiments, at least one hexagonally-shaped reactor contains eight individually-controlled magnetrons. In some embodiments, the at least one magnetron comprises a single magnetron coupled to a waveguide; and wherein the delivery system includes a rotating table for positioning parts in the processing area or chamber.

A method of brazing according to some embodiments of the present invention includes placing parts to be brazed in proximity to one another in a multi-mode chamber; placing a filler material in an area between the parts; igniting a plasma at atmospheric pressure proximate to the parts; controlling the plasma to control a temperature of the parts such that the filler material is melted; and removing the plasma to cool the parts such that the parts are joined.

An atmospheric pressure plasma microwave processing apparatus according to some embodiments of the present invention includes a processing area or chamber wherein parts are processed; at least one multi-mode microwave reactor coupled to receive parts for processing; at least one magnetron coupled to at least one multi-mode microwave reactor to provide microwave energy; and a delivery system coupled to at least one multi-mode microwave reactor to deliver the parts into and out of at least one reactor, wherein a plasma can be generated at atmospheric pressure and provided to the parts in at least one multi-mode microwave reactor, capable of performing a method of brazing by performing the steps of: placing parts to be brazed in proximity to one another in a multi-mode chamber; placing a filler material in an area between the parts; igniting a plasma at atmospheric pressure proximate to the parts; controlling the plasma to control a temperature of the parts such that the filler material is melted; and removing the plasma to cool the parts such that the parts are joined. In some embodiments, the at least one magnetron comprises a single computer-controlled magnetron, and wherein the heated part or parts are contained within a cavity.

A method of carburizing a steel alloy part according to some embodiments of the present invention includes placing the part in a ceramic cavity within a chamber; flowing an inert gas into the ceramic cavity; igniting a plasma in the ceramic cavity with microwaves at atmospheric pressure; introducing acetylene into the plasma once the temperature has reached a determined temperature; maintaining the temperature at a fixed level for a preset amount of time by adjusting a microwave power; and quenching the part.

An atmospheric pressure plasma microwave processing apparatus for carborization according to the present invention includes a processing area or chamber wherein parts are processed; at least one multi-mode microwave reactor coupled to receive parts for processing; at least one magnetron coupled to at least one multi-mode microwave reactor to provide microwave energy; and a delivery system coupled to at least one multi-mode microwave reactor to deliver the parts into and out of at least one reactor, wherein a plasma can be generated at atmospheric pressure and provided to the parts in at least one multi-mode microwave reactor, capable of performing a method of carburizing a steel alloy part by the steps of: placing the part in a ceramic cavity within a chamber; flowing an inert gas into the ceramic cavity; igniting a plasma in the ceramic cavity with microwaves at atmospheric pressure; introducing acetylene into the plasma once the temperature has reached a determined temperature; maintaining the temperature at a fixed level for a preset amount of time by adjusting a microwave power; and quenching the part.

It is to be understood that both the foregoing general description and the following detailed description are exemplary and explanatory only and are not restrictive of the invention, as claimed. Additional embodiments are further discussed with respect to the accompanying drawings, which are incorporated in and constitute a part of this specification.

### BRIEF DESCRIPTION OF THE DRAWINGS

FIG. 1 illustrates a multiple-magnetron plasma tunnel process chamber according to some embodiments of the present invention.

FIG. 2 shows a plasma contained within a quartz vessel.

FIG. 3 shows a rotating table method processing apparatus according to some embodiments of the present invention.

FIG. 4 shows a schematic of a multiple reactor system.

FIG. 5 shows a three-reactor system according to some embodiments of the present invention.

FIG. 6 shows cooling pods of a reactor system.

FIGS. 7 and 8 illustrate modeled electric and magnetic field configurations in a reactor according to some embodiments of the present invention.

FIGS. 9 through 11 illustrate different views of a reactor according to embodiments of the present invention.

FIG. 12A illustrates a system of an embodiment of the present invention for brazing applications.

FIG. 12B illustrates in more detail some components of the system of FIG. 12A.

FIG. 13 shows the placement of a part, for example a “Banjo Block,” for brazing to another part, for example a steel tubing.

FIG. 14 shows a microwave system according to an embodiment of the present invention for carburizing steel alloys.

FIG. 15 illustrates a front view of a concentric double wall ceramic cavity with thermal insulation utilized in some embodiments of the present invention.

FIG. 16 shows a cross section of a sample, indicating where the sample was sectioned.

FIG. 17 shows a cross section of the top of a sample where the ASTME112 grain size is 10-12 in the case and 8-9 in the core.

FIG. 18 shows the cross section of the bottom of a sample where the ASTME112 grain size is 10-11 in the case and 9-10 in the core.

FIG. 19 shows the typical top surface of a sample that has retained autenite (˜25%-35%) to an average depth of about 0.139 mm.

FIG. 20 shows the hardness as a function of depth for both sides of a sample.

FIG. 21 shows the hardness as a function of depth for both sides of a second sample.

FIG. 22 shows the hardness as a function of depth for both sides of a third sample.

FIG. 23 illustrates the carbon depth profiles for side A of the three samples illustrated in FIGS. 20, 21, and 22.

FIG. 24 illustrates the carbon depth profiles for side B of the three samples illustrated in FIGS. 20, 21, and 22.

### DETAILED DESCRIPTION

In 1998, Dana Corporation began developmental work in the field of directed energy methods for manufacturing processes. In late 1999, this led to the discovery of a novel method for producing and maintaining plasma at atmospheric pressure using microwaves (AtmoPlas™). Since the initial discovery of creating and controlling very high-density plasma, many new processes have emerged that were not previously possible using microwaves at atmospheric pressure—for example heat treating, brazing, coatings, PM sintering, surface engineering, generation of nanotubes and other structures, and treatment of exhaust gases. In some cases, concurrent processing can be accomplished. This new technology allows existing processes such as chemical vapor deposition (CVD) to occur at atmospheric pressure, where no expensive vacuum chamber equipment is required.

This disclosure provides methods of utilizing this new technology, the AtmoPlas™ process, in manufacturing processes. The AtmoPlas™ process is described, for example, in commonly assigned applications PCT/US03/14037, PCT/US03/14124, PCT/US03/14132, PCT/US03/14052, PCT/US03/14054, PCT/US03/14036, U.S. application Ser. No. 10/430,414, PCT/US03/14034, U.S. application Ser. No. 10/430,416, U.S. application Ser. No. 10/430,415, PCT/US03/14133, PCT/US03/14035, PCT/US03/14040, PCT/US03/14134, PCT/US03/14122, PCT/US03/14130, PCT/US03/14055, PCT/US03/14137, PCT/US03/14121, PCT/US03/14136, and PCT/US03/14135, each of which is herein incorporated by reference in their entirety. Further description is provided in S. Kumar, D. Kumar, K. Cherian, M. Dougherty “Carburization of Steel Alloys by Atmospheric Microwave Plasma”, The Fourth World Congress on Microwave and Radio Frequency Applications, Nov. 7-12, 2004; D. Kumar, S. Kumar, K. Cherian, M. Dougherty, “Efficient Brazing with Microwaves”, The Fourth World Congress on Microwave and Radio Frequency Applications, Nov. 7-12, 2004; and K. Cherian, S. Kumar, D. Kumar, M. Dougherty, “Powder Metal Sintering by Atmospheric Microwave Plasma”, The Fourth World Congress on Microwave and Radio Frequency Applications, Nov. 7-12, 2004, each of which is herein incorporated by reference in its entirety.

History has proven that a one-step transformation from initial development of a new process to a viable, large-scale manufacturing process is seldom successful. Hence, a scaled-up prototype of an apparatus that utilizes the process and addresses all of the known requirements for a manufacturing environment can be developed. Material handling methods, safety, operator ergonomics, ease of maintenance, and failsafe controls are just a few of the elements to consider in such a prototype. A scaled-up prototype provides a test bed for optimizing the processes in a manufacturing environment. One of the many purposes of such a prototype system is to determine what parameters need not be tightly controlled in an actual manufacturing system.

As mentioned above, conventional heat treatment processes typically require maintaining large thermal masses (furnaces) in order to conduct and radiate the heat to the parts being treated. Conventional furnaces require large amounts of energy, whether or not parts are actually being processed. The AtmoPlas™ process places the heat where it is required, without the need to heat up other areas. The high-density plasma surrounding the part(s) has a very low thermal mass. Once the plasma is ignited, which is substantially instantaneous, over 90% of the microwave energy is absorbed in the plasma. The plasma acts like a microwave “Magnet” due to its very strong coupling with the microwave field; hence, minimal amounts of microwave radiation get reflected back to the magnetron. Because of the low microwave reflectance from the plasma, the use of multiple magnetrons in processing metal materials is possible. Use of multiple magnetrons has not been possible in the past.

In many processes; for example, Powder Metal (PM) Sintering, the limiting temperature for processing is on the order of 1200° C. to 1250° C. This limitation is imposed by the furnace belts and their associated “stretch” that occurs when processing in a continuous manner at high temperature. PM Sintering companies would prefer to produce their parts at higher temperatures, which improves material properties and can get closer to desired densities. With the AtmoPlas™ Process, heat is put into the part, and isolated from the belts. Hence, PM Sintering can be performed, for example, at temperatures in excess of 1450° C.

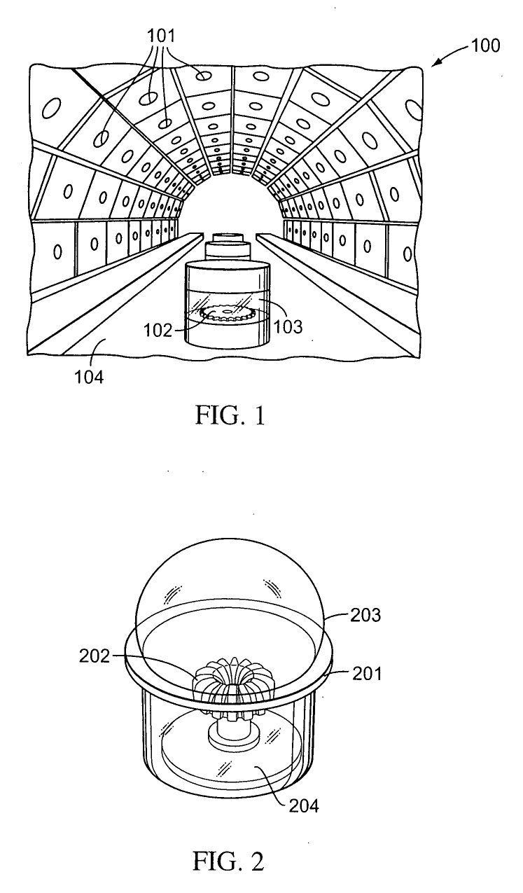

FIG. 1 illustrates a view into a belt-driven processing system 100. In the system shown in FIG. 1, multiple magnetrons 101 are used. The heated parts 102 are contained within their own “cavity” or environment 103, which contains the plasma energy and isolates it from the moving belt 104. Single parts and multiple parts can be processed in this system. The amount of power utilized in the process is a function of the part mass and the amount of processing time required.

The AtmoPlas™ technology provides localized heating; additionally it provides an atmospheric pressure plasma reactor. Hence, it is expected that in future embodiments, concurrent processes can be accomplished, such as sintering PM and super carbulizing, or heat treating and coating in the same processing chamber. Any gas that can be ionized into plasma can include species that can be imparted to the target components. The AtmoPlas™ process is faster in heating metals than most conventional processes except for induction heating. However, no complex-shaped, expensive coils are required. In addition, non-metal parts can also be processed using this system. In some embodiments, several such processing lines can be fed into a common piece of equipment such as a forging press or a squeeze-quenching piece of equipment in a “star” configuration.

In the AtmoPlas™ technology, once the plasma is ignited, the temperature rapidly rises to 1000° C. in about 4 seconds. The practical upper temperature limit is still unknown. The limiting factor at this point is the ability of the containment materials to withstand high temperatures. Containment materials often must be able to withstand both thermal shock and high temperatures for extended periods of time, depending upon the process. Additionally, containment materials can be transparent to microwave radiation. Typical materials for the cavities within the reactor are ceramic, quartz, or other high-temperature material.

FIG. 2 shows plasma that is contained within a quartz vessel 201. The plasma shows a plasma sheath 203 surrounding a gear 202 and a second form of plasma 204 outside the sheath. Quartz was chosen as the material for the quartz containment vessel 201 because of its temperature and thermal shock properties, as well as its transparency, which enables uninhibited observation of the process.

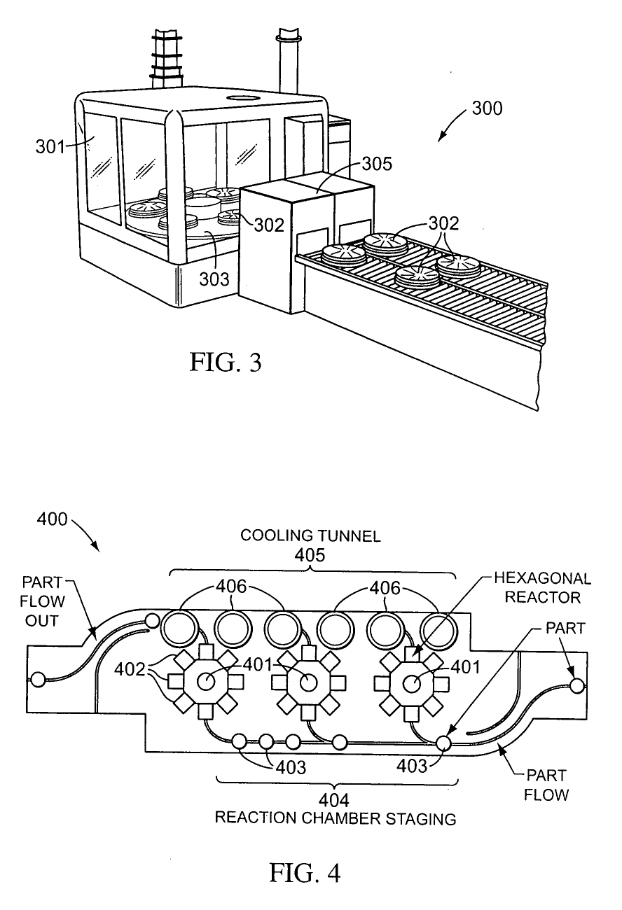

In the embodiment of a processing system 300 shown in FIG. 3, multiple part cavities 302 are fed onto a rotating table 303 and are then positioned below a single magnetron “horn” 305, consisting of a magnetron 304 coupled to a waveguide 305, which reaches into the main processing area 301. Note that the ceramic part carriers 302 pass through an air lock 305 upon entering and exiting the main processing area 301. Once the part carriers 302 are in proper position, they are raised up to the horn 304, where processing occurs. Hence, each part is contained within its own cavity 302 where the plasma is formed for processing the parts. The processing time of each part can be controlled using computerized indexing tables. It should be noted that although the processing system 300 illustrated in FIG. 3 utilizes a single high-powered magnetron, multiple magnetrons can be used as well.

One embodiment of a multiple-magnetron system 400 appears in the schematic FIG. 4. Each reactor 401 is hexagonal in shape and contains 8 individually controlled magnetrons 402. Each reactor is independent of the other reactors. Hence, the system can handle multiple different processes—for example, carburizing, brazing, and sintering—simultaneously. Part carriers 403 can be sent to the appropriate station using bar coding methods, for example. The radiation staging area 404, which is where the parts are sorted and wait before entering a reactor, can also be used as a preheating area, if desired for the particular process. This embodiment of the processing system includes a cooling tunnel 405 on the exit side of the reactors, where parts can be sorted and held an appropriate amount of time, depending on the specifications of the process being applied, before exiting the processing system.

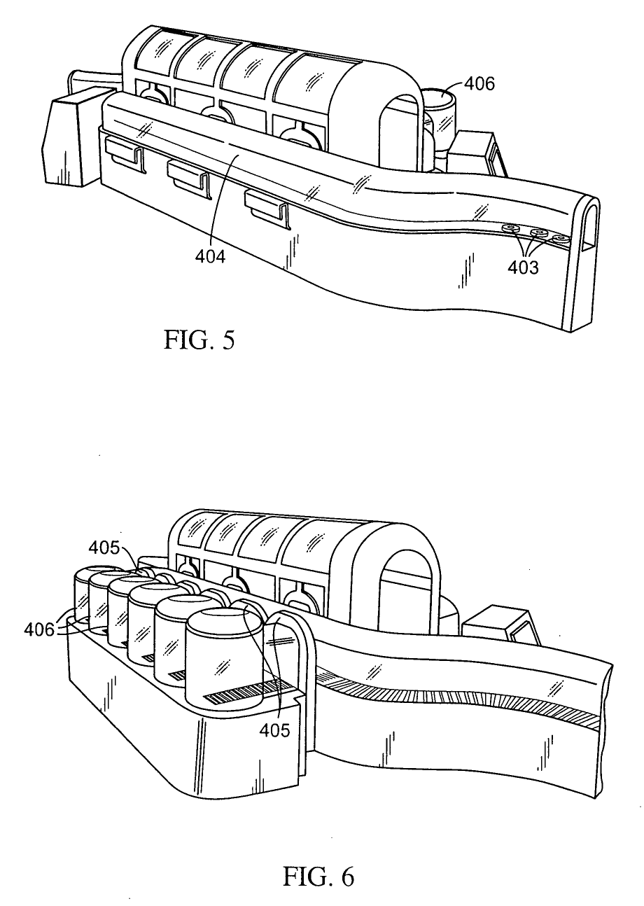

Under computer control, each reactor 401 raises and lowers over the parts 403 to be processed. Upon cycle completion, the parts 403 exit the reactor 401 and are directed to individually-controlled cooling pods 406, or are directed out of the system for the next processing steps. A schematic of a multiple reactor system is illustrated in FIG. 4. FIG. 5 shows an external rendering of a three-reactor system according to some embodiments of the present invention, similar to system 400 described above, from the radiation chamber side. FIG. 6 shows an external rendering of a three-reactor system according to some embodiments of the present invention, similar to system 400 described above, from cooling pod side.

Aside from the ability to run multiple processes, another feature of this system is that additional reactors can be added to achieve the desired manufacturing rates.

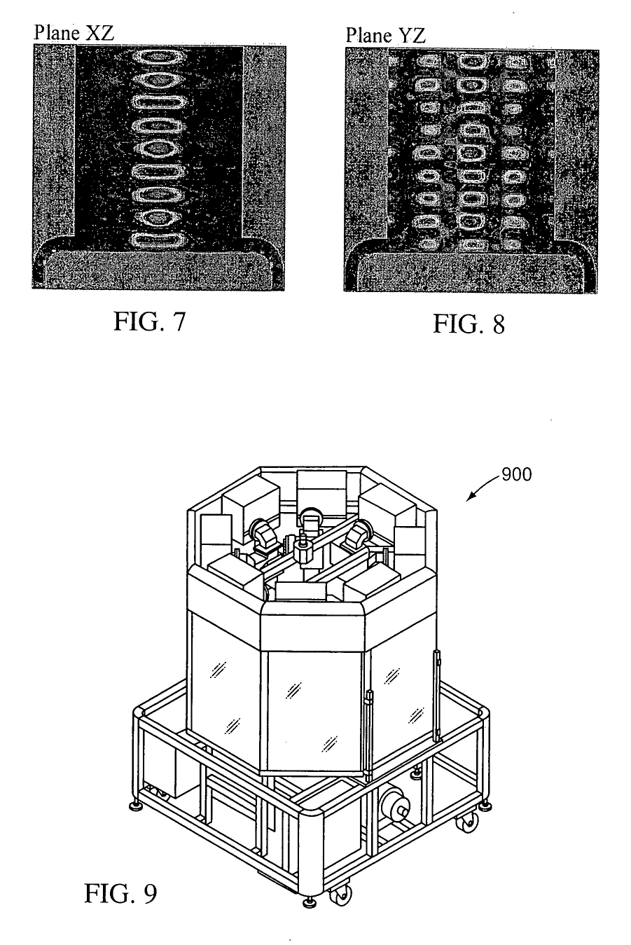

The hexagonal reactor shape described in the system 400 embodiment has been modeled to study E-H field distribution. Some of the results of these studies are shown in FIGS. 7 and 8. FIG. 7 shows the E-H field distribution of the hexagonal reactor shape in the XZ plane. FIG. 8 shows E-H field distribution of the hexagonal reactor shape in the YZ plane.

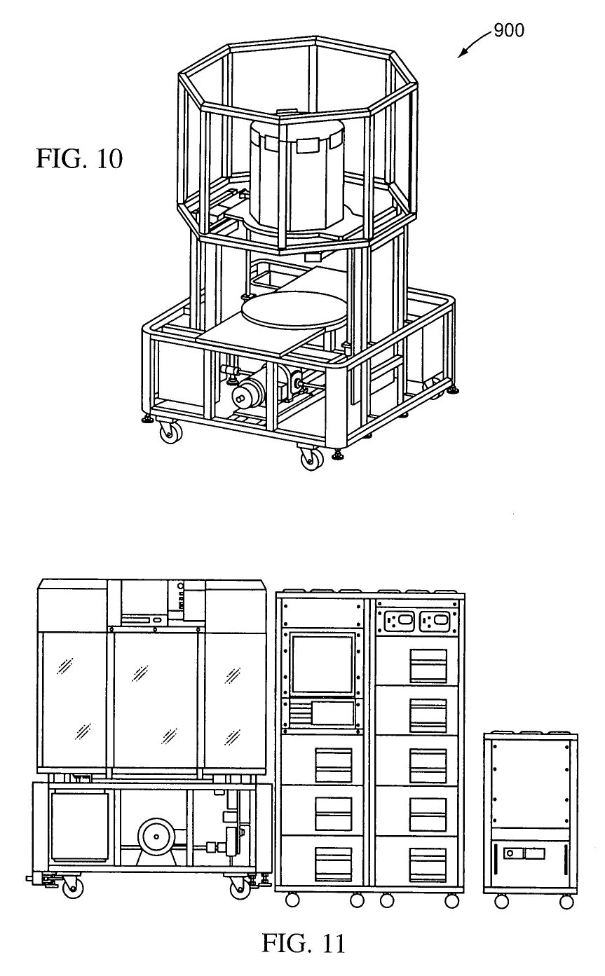

FIGS. 9 and 10 illustrate different views of a single hexagonal reactor 900 that has been built and is currently undergoing extensive testing. FIG. 11 illustrates the same reactor system 900 with its associated cabinet of computer and other electronic equipment. The system is capable of providing 48 KW of microwave power, distributed between 8 magnetrons. Each magnetron is individually controlled from 0 to 100% power in any combination that is required for the desired process. Radiation detectors, failsafe defaults, mass flow controllers for four individual gases, magnetrons and reactor cooling are just some of the features included. Additionally, provisions for applying DC-Bias to the products to be processed are included.

This disclosure presents a compendium of developed processes to provide methodology-containing flexibility and expandability for atmospheric microwave processing in industrial environments. The methods were developed for inline systems, semi-continuous systems, and batch systems. They can also be configured for cellular manufacturing methods.

### Brazing

The AtmoPlas™ process is capable of a wide variety of applications that include not only the heat related processes (e.g., Brazing, Sintering, Carburizing, Heat Treatment, Tempering, etc.) but plasma-chemistry assisted processes as well (e.g., Coating, Carburizing, Nitriding, Exhaust Treatment, etc.). This disclosure presents some results on brazing of steel and of aluminum using the AtmoPlas™ process.

Joints have been successfully brazed in several automotive parts using the AtmoPlas™ process: for example, copper brazing of 1008 steel ‘banjo block’ and hose fittings to tubes (parts used in brake lines) and brazing of an aluminum 6061-T4 block to 3003 tube (‘P-nut block’ used in HVAC systems). Test results and processing cost comparisons indicate that the AtmoPlas™ process can be used for industrial production. The primary benefits of using AtmoPlas™ come from the low thermal mass of the heat source, good temperature control, and the ability to deliver the heat only where it is needed.

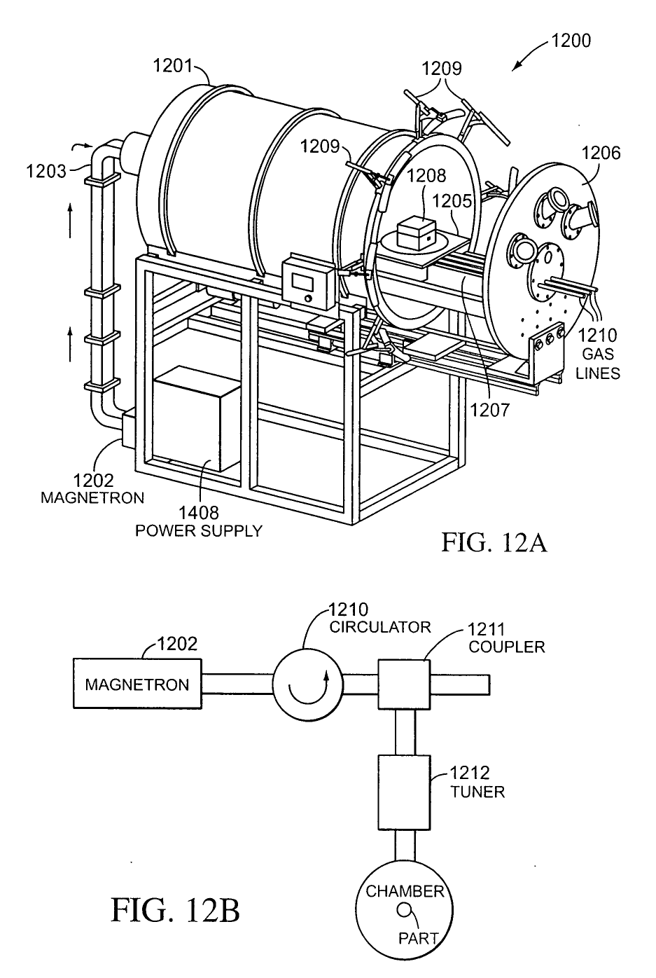

FIG. 12A shows a sketch of a system 1200 according to some embodiments of the present invention that can be used for brazing applications. This system 1200 includes a computer-controlled 2.45 GHz magnetron 1202 that can generate continuously variable power from 0.5 to 5 KW. This power can be controlled as a function of time or temperature to achieve a suitable time-temperature profile. The microwave power is fed from magnetron 1202 through waveguide sections 1203 into a 32″ diameter, 50″ long aluminum applicator chamber 1201 via a circulator 1210, a dual directional coupler 1211, and a 3-stub tuner 1212 as shown in FIG. 12B. These components, respectively, protect magnetron 1202 from any reflected microwave power, can measure the forward and reflected power into/from the chamber, and allow impedance matching to minimizing the reflected power from the applicator. A properly tuned 3-stub tuner couples almost 100% of the microwave energy into the plasma load. A closed loop deionized water-cooling system cools magnetron 1202, circulator 1210, aluminum applicator chamber as well as the 32×22″ working platform 1205 inside the chamber. A rotating mode mixer inside the chamber improves the time-averaged uniformity of the microwave field. The working platform 1205 is attached to the door 1206 that is mounted on a sliding railing 1207. The embodiment illustrated in FIG. 12A is one example of an apparatus that can be utilized with the present invention. One skilled in the art will recognize that other apparatuses can be utilized including the chambers discussed above in the disclosure.

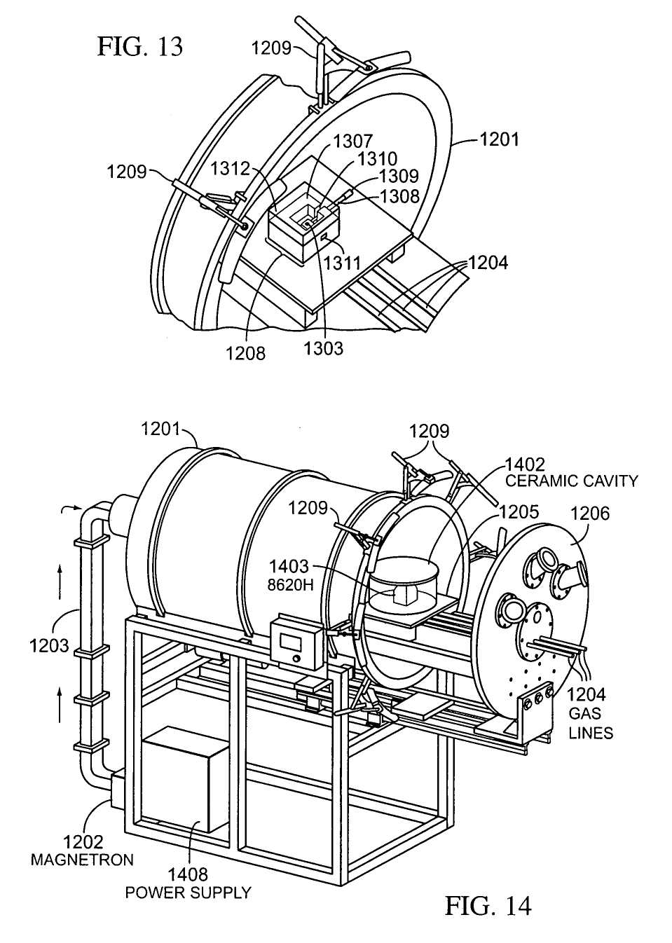

The braze joint and some surrounding areas of the sample part 1208 are kept inside a plasma confining cavity (visible at 1402 in FIG. 14) made of a ceramic material rated at 30000F. Alternatively, quartz cavities can be used with one or more layers of high temperature ceramic insulation to prevent significant heat loss from the cavity. FIG. 13 is a close up view of the plasma cavity 1402 with the sample part 1208 inside. The ceramic material can be transparent to the microwave radiation. Stainless steel tubes 1204 are used to provide an inert gas to the ceramic cavity 1402 and to exhaust the fumes generated in the brazing process. The temperature of the part can be measured by a remote sensing dual color optical pyrometer, which can have an accuracy of +/−0.33% of the reading and a response time of 500 ms. The pyrometer can sense the temperature of the target surface through the plasma as no plasma interference is detected.

The large size of the applicator chamber 1201 supports a large number of chamber cavity modes. The action of a rotating mode-mixer can help to further smear out the instantaneous fields to provide a reasonably uniform time-averaged field distribution in the chamber 1201. Thus, a fairly uniform heat flux can be achieved. The plasma, therefore, only takes a few seconds to stabilize before forming a uniform plasma field around the part. Because it is the plasma that heats up the metal, rather than the microwaves directly, the heat flux around the part can be shaped to match the part by adjusting the thickness of the plasma layer around the part, if necessary. Other commercial furnaces do not offer the flexibility to easily adjust the heat flux around the part.

Safety interlocks 1209 prevent accidental starting of the system. In addition, radiation leak monitors automatically shut down the system in case any leakage is detected above the safe limit specified by the applicable regulatory authority.

As an example of an application of this device and brazing technique, FIG. 13 shows the placement of an automobile hydraulic brake part 1303 consisting of a ‘Banjo block’ 1307 (the rectangular 1008 low-carbon steel block) to be brazed to the steel tubing 1308. The other end of the tubing 1309, which is outside the ceramic cavity, is to be brazed to a tube fitting (as shown in FIG. 13). Because it is undesirable to heat the whole length of the tubing, the brazing process is carried out in two separate runs in which the heating is confined to the vicinity of the joint. This multiple-run process helps to minimize or eliminate thermal stress over areas that need not be heated and optimize energy utilization. It is also possible to carry out brazing of both joints simultaneously using a larger cavity, or using a split/dual cavity system.

Before activation of the microwave plasma, a copper braze ring is slipped over the tube at the banjo block joint, a small amount of flux is applied to the joint, and the part is placed in the ceramic cavity 1402. The opening 1310 in the slot on the right hand side of the cavity is blocked with a small piece of ceramic. The pyrometer monitors the surface temperature of the part through a small hole 1311 in the front of the ceramic block. A top cover 1312 (also of ceramic) is placed over the open cavity 1402 to create an enclosed volume that can keep the plasma as well as the heat confined. Air in the ceramic cavity 1402 is flushed out with some inert gas and plasma is ignited using the AtmoPlas™ process, which is simple, inexpensive, and occurs almost instantaneously when the microwave power is applied.

An aluminum ‘P-Nut’ block used in the HVAC system has also been brazed successfully to aluminum tubing. Because the melting temperature of aluminum is quite low (˜660° C.) and the difference between the melting temperature of aluminum and the corresponding filler metal alloy is also very small (30-40° C.), temperature tolerance requirements for applying the brazing process to aluminum are much more stringent than the tolerances used for steel.

Applicants have conducted experiments to investigate the feasibility of using microwaves to efficiently heat the metal work-pieces to be brazed, and whether microwaves have any adverse effects on the quality of the braze joint. Briefly, a brazing process involves joining two metal work-pieces with a “filler” metal whose melting temperature is lower than either of the two work-pieces. The two metal work-pieces are placed, held, or joined together and a small amount of filler metal (and flux for cleaning/wetting, if needed) is applied to the joint. The joint is then heated to a temperature that is high enough to melt the filler metal but not the two work-pieces. The capillary action is usually good enough to pull the molten filler metal between the mating surfaces of the work-pieces to make a good joint.

In the brazing experiment just described, at a power level ranging from 2.5-1.5 KW, the copper braze ring at the banjo-block end melts in 80-85 seconds whereas only 55-60 seconds are needed to melt the braze ring at the tube-fitting end (due to reduced thermal mass). The processed work-piece is allowed to cool in a suitable environment to complete the brazing process. The processed work-piece is then plated for corrosion resistance, fitted with an appropriate length of the brake hose, bent to shape to emulate a standard manufactured part, and then subjected to a rigorous testing to check if it can meet/exceed the acceptance criteria that is used for the standard manufactured parts.

Some of the results of testing are as follows:

### 1. Tensile Test for the Joint:

TABLE I

| Sample | Load (Lb) | Observation |
|---|---|---|
| A. Current Production | 2610 | Tube broke before braze |
| Brazing | | failed |
| B. Atmoplas ™ Brazing | 2661 | Tube broke before braze |
| | | failed |

### 2. Other Tests on Complete Parts Made with AtmoPlas:

| | | Pass/ |
|---|---|---|
| Test | Results | Fail |
| Pressure/Probe/ | 43 samples tested - no failures | Pass |
| Constriction | | |
| Volumetric | 0.09 cc/ft @ 1000 psi; 0.12 cc/ft @ 1500 psi | Pass |
| Expansion | | |
| Burst | Average burst pressure - 11,654 psi | Pass |
| Whip | 35 Hrs. - No Failure | Pass |
| Tensile | Average tensile strength - 602 lbs | Pass |
| Water Absorption | Burst: Burst pressure 11,105 psi | Pass |
| | Tensile: Tensile strength 767 lbs | |
| | Whip: 40 Hrs. - No Failure | |
| Low Temperature | 72 hrs @ −57° C. - no cracks observed | Pass |
| Flexibility | | |
| Brake Fluid | Average burst pressure - 12,370 psi; | Pass |
| Compatibility | no constriction found | |
| Corrosion | 1,224 Hrs -small amount of Red Rust @ | Pass |
| Resistance | Serrations, braze joint fine. | |
| Dynamic Ozone | Surrogate data from HB5439-0116 | Pass |
| Heat Age & Cold | 240 hrs @ 120° C., men 48 hrs @ −47° C. - | Pass |
| Bend | no cracking observed | |
| Impulse | 150 cycles @ 0-1600 psi, then burst - | Pass |
| | average burst pressure 13,052 psi | |

The braze joints prepared by the atmospheric pressure microwave plasma method Atmoplas™ were found to be as good as the traditionally brazed joints, as no adverse effects on any characteristics of the parts have been detected.

It is observed that 95-100% of the microwave energy can be transferred to the hot plasma by proper tuning, making Atmoplas™ a very fast and efficient heating process. Operating at less than 40% power level, the copper brazing process at the banjo-block end was completed by exceeding ˜1100° C. temperature in 80-85 seconds. No precise estimation is made of the amount of heat conducted away by the tube that extends outside the hot ceramic cavity.

Detailed testing on aluminum parts brazed with the Atmoplas™ process has not been carried out. However, initial success indicates that the Atmoplas™ process is, indeed, capable of brazing aluminum parts. Because more stringent temperature controls are required in working with aluminum, any scale up for large volume production or large size parts will require multipoint temperature sensing as well as controlled heat flux.

To reduce the system cost of implementing Atmoplas™ for large-scale manufacturing applications, future embodiments could use a large number of low-power magnetrons to handle the required throughput rates. Such an implementation would not only reduce the system cost but also would permit easier manipulation of the microwave field distribution over the working volume.

Brazing with Microwave Plasma at atmospheric pressure has been carried out successfully with various automotive as well as non-automotive parts. The coupling efficiency of the microwave to the plasma can be extremely high. This and several other benefits associated with microwave plasma processing at atmospheric pressure, i.e., Atmoplas™, reveal its enormous potential not only for brazing but also for a wide variety of other applications.

### B. Carburization

In the Atmoplas™ process, the plasma fills the cavity volume and can be made to surround the part uniformly. This allows Atmoplas™ the potential to be used in a wide variety of commercial applications. This section of the disclosure describes an application of Atmoplas™ to carburization of steel parts. As is well known, there are many ways to produce hard, wear resistant surfaces of parts with softer cores. Carburization is one such process and is well understood, well established, and one of most widely used processes in industry. When a hard, wear-resistant surface is needed, one can start with a steel alloy that already has sufficient carbon to provide the required hardness after heating and quenching or, alternatively, start with low-carbon steel and change the composition of the surface layers. Carburization is associated with the second approach and takes place when austenitized steel is exposed to sufficient carbon potential to create a concentration gradient from the surface to the interior. There are two factors that control the rate of carburization: a) the surface reaction for carbon absorption and b) diffusion of carbon in the metal. In general, carburization for low-carbon steels (less than 0.2 weight percent carbon) is done at around 920° C.; the surface carbon is usually raised to about 1%. At carburization temperatures (˜900° C.), the steel surface is very active. Because the depth of the carburization depends on the diffusion process, it can be regulated by controlling the time and temperature. Although carburization rate can be increased considerably by raising the temperature greater than 950° C., it is not done in practice due to the reduction in life of the conventional furnaces as well as undesirable metallurgical effects (e.g. grain growth, intergranular oxidation, etc.) that are associated with higher temperatures.

In the Atmoplas™ process, acetylene breaks down very efficiently when exposed to microwave power at a microwave frequency (2.45 GHz) and provides sufficient carbon potential for carburization. Because the carbon potential in the Atmoplas™ process depends primarily on the acetylene flow rate, microwave power, and the cavity volume, there is some flexibility in controlling carbon potential.

FIG. 14 shows an example carburization system 1400, used for carburization of an 8620H steel alloy. This system can deliver up to 6 kW of continuous power at 2.45 GHz. The outer cylindrical chamber 1201 (32″×50″ long) is made of aluminum and is water-cooled. The magnetron 1202 and the power supply 1408 are mounted under the chamber. Microwave energy is fed via a waveguide 1203 to the aluminum chamber 1201. A three-stub tuner is used in the waveguide section to match the impedance of the magnetron to the plasma (load). An isolator is used to protect the magnetron by transferring the reflected microwave power to the water load. Inside the aluminum chamber 1201, a mode stirrer makes the microwave field uniform in the chamber volume. As shown in FIG. 14, the cylindrical chamber 1201 has a sliding door on one side with an attached horizontal aluminum platform. The 8620H sample 1403, which is 1″ dia., 0.625″ thick, is placed inside a ceramic cavity 1402, which sits on this horizontal platform 1205. Stainless steel tubes 1404 are used to provide various gases to the ceramic cavity 1402. To prevent any leakage of microwave radiation from the chamber 1201, there are various safety interlocks in the system. The temperature of the part is measured by a dual wavelength pyrometer. The pyrometer is quite accurate and selects the temperature of the part through the plasma unless the emission wavelengths of the plasma interfere with the operating wavelengths of the pyrometer.

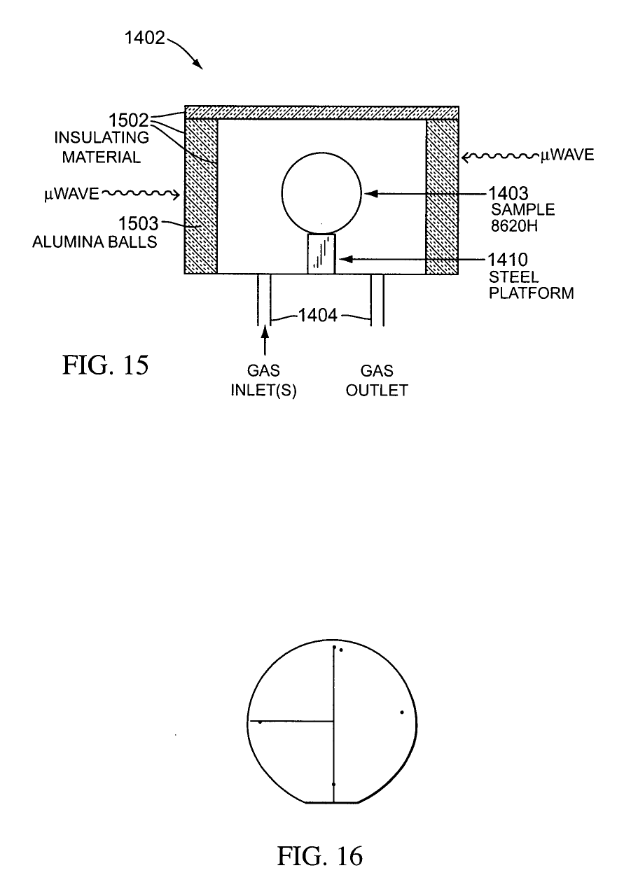

FIG. 15 illustrates a front view of a concentric double wall ceramic cavity 1402 with thermal insulation 1502 that can be utilized in some embodiments of the system 1400. The insulating material 1502 can be ceramic or quartz in some embodiments of the present invention. Two layers of insulating material 1502 surround inner-insulating alumina balls 1503. Sample alloy 1403 rests on steel platform 1205 during processing. Tubes 1404 carry gases into and out of the cavity.

The carburization process is quite simple. After placing the sample in the ceramic cavity 1402, the chamber door 1206 is closed and argon gas is allowed to flow into the ceramic cavity 1402. Plasma is ignited by the Atmoplas™ process and the temperature is allowed to rise. When the temperature of the sample is about 920° C., acetylene is introduced in the cavity 1402. The temperature is maintained at a fixed level for a given amount of time by adjusting the microwave power. The part 1403 is oil-quenched after carburization and then tempered for one hour at 177° C.

Processing parameters of three samples using system 1400 are provided. The results of metallurgical analysis to determine microhardness, microstructure and carbon profile are presented in the next section.

### Sample 1

### Average temperature=950° C.

### Carburization cycle time=90 minutes

### Ar=0-110 min

### C₂H₂=20-110 minutes

### Oil quenched, tempered 1 hour @177° C.

### Sample 2

### Average temperature=928° C.

### Carburization cycle time=120

### Ar=0-140 min

### C₂H₂=24-120 minutes

### Oil quenched, tempered 40 minutes @ 177° C.

### Sample 3

### Average temperature=920° C.

### Carburization cycle time=3 hours

### Ar=0-200 min

### C₂H₂=20-200 minutes

### Oil quenched, tempered 1 hour @177° C.

The micro hardness was measured at several locations on the sample surfaces and the HRC (Rockwell C-scale measure of hardness) range measured for sample 1 was between 62.7 and 64.1. Similar ranges for samples 2 and 3 were HRC 61.3-62.8 and 61.6-64.1 respectively. These hardness values of microwave plasma carburized samples are comparable to samples carburized in the conventional manner.

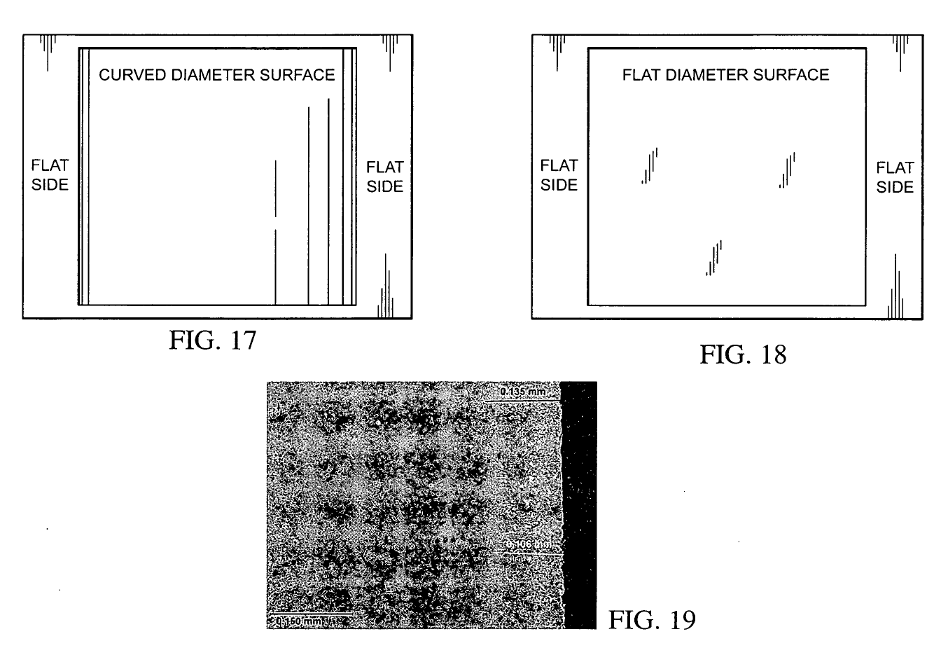

FIG. 16 shows how all three samples were sectioned for analysis and FIGS. 17 and 18 show the uniformity of carburization on all sides for sample 1. These figures demonstrate the possibility that the heating and carbon potential is uniform on all sides of the samples.

FIG. 19 shows a typical top surface of sample 1 that has retained autenite (˜15%-35%). The average depth of retained austenite was about 0.139 mm. The retained austenite on the sides of the samples averaged between 25% to 35% and at the corner it was found to be at higher level (around 60-70%). Retained austenite microstructure is soft and is responsible for reduction in hardness. The amount of retained austenite existing after quenching can be further reduced by deep cooling (−196° C.). Deep cooling causes more austenite to transform into martensite phase.

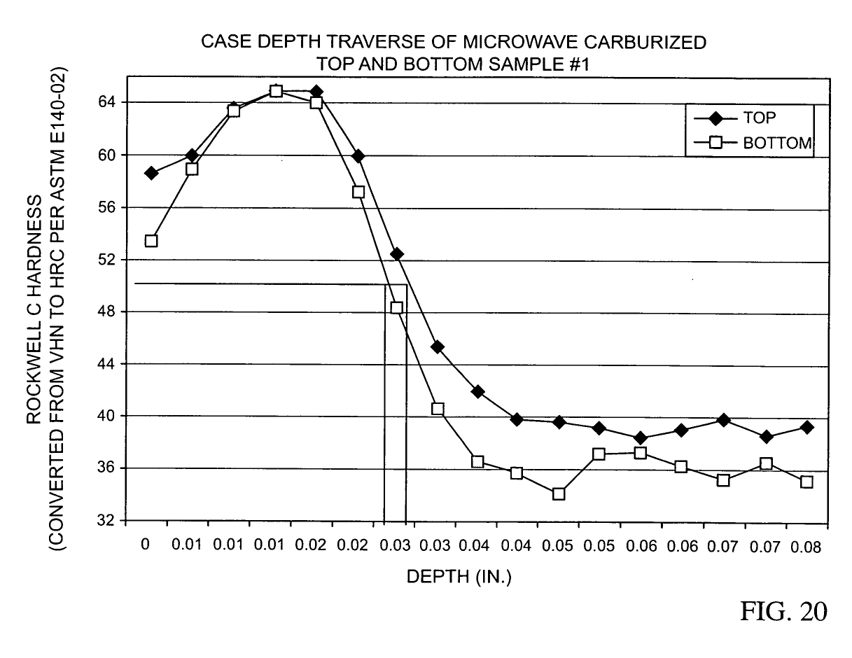

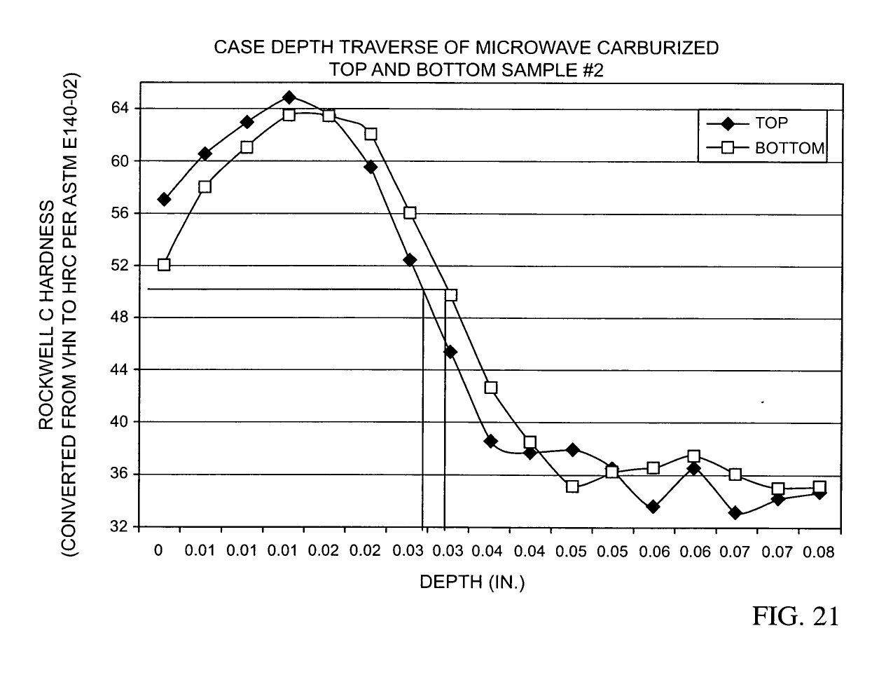

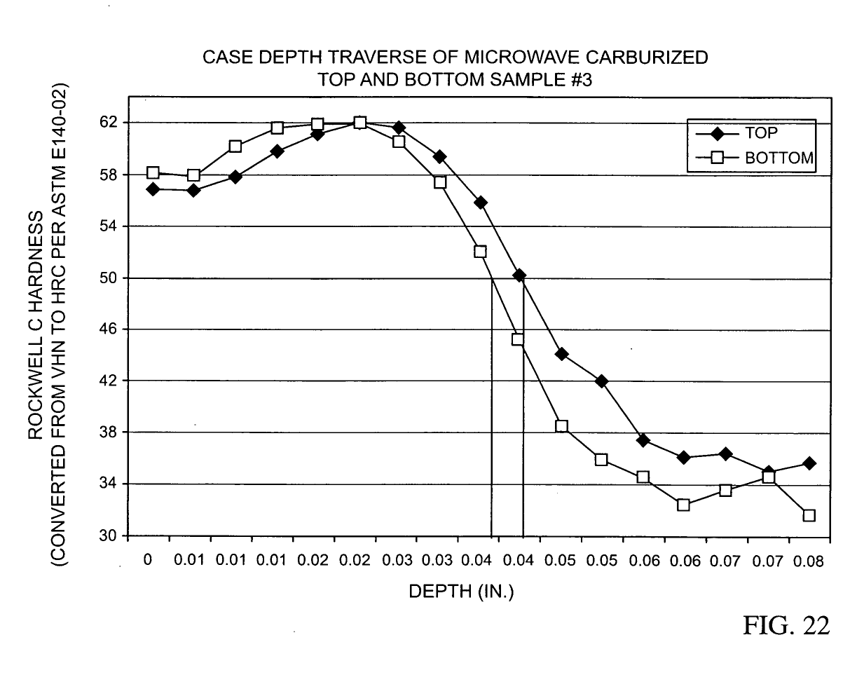

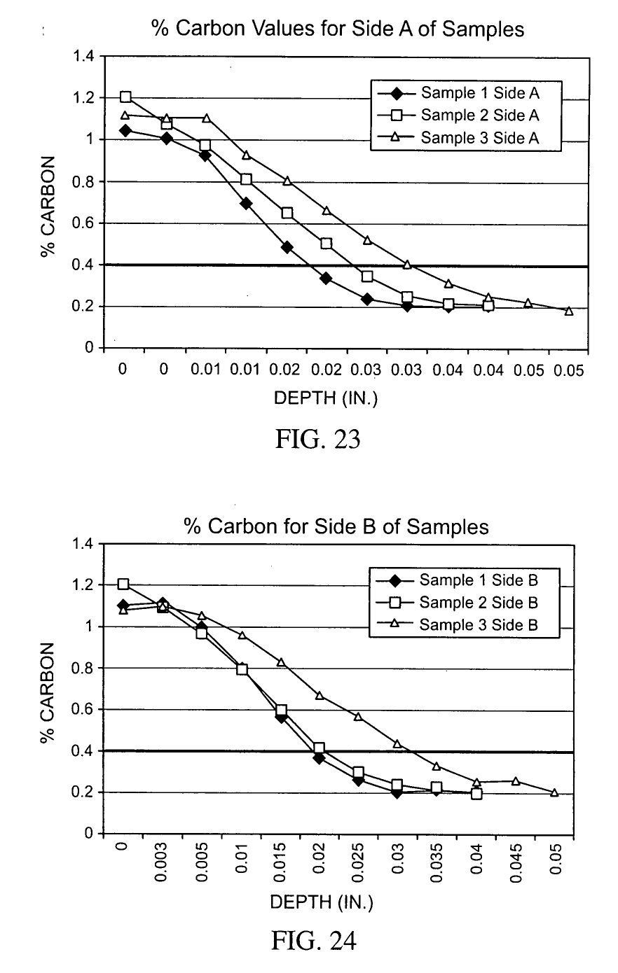

FIGS. 20-24 show the microhardness and the carbon depth profile for these samples. The carbon percent at the surface is between 1 and 1.2% which can be adjusted to the required value by varying the acetylene flow rate and also by cycling of acetylene flow rate and the temperature. Adjusting the microwave power allows for easy control of temperature during the Atmoplas™ process.

There is now a trend to carburize at higher temperatures (980° C.) for certain deep case requirements. In the Atmoplas™ process, the plasma/heat is confined to the ceramic cavity, which could be placed on a conveyer belt of a microwave furnace. This allows temperatures inside the cavity to be much higher (because the plasma is confined inside the cavity) without heating the conveyer belt and other furnace components. Thus, carburization in Atmoplas™ can be performed at much higher temperatures (>980° C.), if needed.

Another advantage of the Atmoplas™ process for carburization is the fact that since it is a plasma process, a pulsed DC bias can be applied to a part that has good electrical conductivity. This method attracts plasma to the part, forming a more uniform plasma layer around the surface and leading to more uniform heating. This method also restricts energy to the part, resulting in a more energy efficient process.

Another future improvement to the current system is a laser gas analyzer, which will allow a more accurate method of determining carbon potential in the cavity.

The Atmoplas™ process is a simple, inexpensive and energy-efficient new atmospheric pressure process that can be used for the carburization of steel alloys. The test results presented in this disclosure for small-size samples of 8620H indicate that this process can provide uniform heating and the carbon potential required for carburization.

We claim:

1. An atmospheric pressure plasma microwave processing apparatus, comprising:
a processing area or chamber wherein parts are processed;
at least one multi-mode microwave reactor coupled to receive parts for processing;
at least one magnetron coupled to at least one multi-mode microwave reactor to provide microwave energy; and
a delivery system coupled to at least one multi-mode microwave reactor to deliver the parts into and out of at least one reactor,
wherein a plasma can be generated at atmospheric pressure and provided to the parts in at least one multi-mode microwave reactor.

2. An apparatus according to claim 1, wherein the at least one magnetron comprises a plurality of magnetrons.

3. An apparatus according to claim 1, wherein the delivery system includes a conveyor belt.

4. An apparatus according to claim 1, wherein the delivery system includes a rotating table system.

5. An apparatus according to claim 1, wherein each of the parts is contained within a cavity.

6. An apparatus according to claim 1, wherein the at least one multi-mode microwave reactor includes a plurality of multi-mode microwave reactors.

7. An apparatus according to claim 1, wherein the delivery system includes at least one cooling pod area for holding parts in the system after processing.

8. An apparatus according to claim 1, wherein the at least one multi-mode microwave reactor includes at least one hexagonally-shaped reactor.

9. An apparatus according to claim 3, where the processing area or chamber is sealed, and
wherein the delivery system includes an airlock through which parts pass into the processing area or chamber.

10. An apparatus according to claim 5, wherein the containment material is composed partially or completely of any type of ceramic.

11. An apparatus according to claim 5, wherein the containment material is composed partially or completely of quartz.

12. An apparatus according to claim 8, wherein at least one hexagonally-shaped reactor contains eight individually-controlled magnetrons.

13. An apparatus according to claim 9, wherein the at least one magnetron comprises a single magnetron coupled to a waveguide; and
wherein the delivery system includes a rotating table for positioning parts in the processing area or chamber.

14. A method of brazing, comprising:
placing parts to be brazed in proximity to one another in a multi-mode chamber;
placing a filler material in an area between the parts;
igniting a plasma at atmospheric pressure proximate to the parts;
controlling the plasma to control a temperature of the parts such that the filler material is melted; and
removing the plasma to cool the parts such that the parts are joined.

15. An atmospheric pressure plasma microwave processing apparatus, comprising:
a processing area or chamber wherein parts are processed;
at least one multi-mode microwave reactor coupled to receive parts for processing;
at least one magnetron coupled to at least one multi-mode microwave reactor to provide microwave energy; and
a delivery system coupled to at least one multi-mode microwave reactor to deliver the parts into and out of at least one reactor,
wherein a plasma can be generated at atmospheric pressure and provided to the parts in at least one multi-mode microwave reactor,
capable of performing a method of brazing by performing the steps of:
placing parts to be brazed in proximity to one another in a multi-mode chamber;
placing a filler material in an area between the parts;
igniting a plasma at atmospheric pressure proximate to the parts;
controlling the plasma to control a temperature of the parts such that the filler material is melted; and
removing the plasma to cool the parts such that the parts are joined.

16. An apparatus according to claim 15, wherein the at least one magnetron comprises a single computer-controlled magnetron, and
wherein the heated part or parts are contained within a cavity.

17. An apparatus according to claim 16, further comprising a closed-loop deionized water cooling system.

18. A method of carburizing a steel alloy part, comprising:
placing the part in a ceramic cavity within a chamber;
flowing an inert gas into the ceramic cavity;
igniting a plasma in the ceramic cavity with microwaves at atmospheric pressure;
introducing acetylene into the plasma once the temperature has reached a determined temperature;
maintaining the temperature at a fixed level for a preset amount of time by adjusting a microwave power; and
quenching the part.

19. An atmospheric pressure plasma microwave processing apparatus, comprising:
a processing area or chamber wherein parts are processed;
at least one multi-mode microwave reactor coupled to receive parts for processing;
at least one magnetron coupled to at least one multi-mode microwave reactor to provide microwave energy; and
a delivery system coupled to at least one multi-mode microwave reactor to deliver the parts into and out of at least one reactor,
wherein a plasma can be generated at atmospheric pressure and provided to the parts in at least one multi-mode microwave reactor,
capable of performing a method of carburizing a steel alloy part by the steps of:
placing the part in a ceramic cavity within a chamber;
flowing an inert gas into the ceramic cavity;
igniting a plasma in the ceramic cavity with microwaves at atmospheric pressure;
introducing acetylene into the plasma once the temperature has reached a determined temperature;
maintaining the temperature at a fixed level for a preset amount of time by adjusting a microwave power; and
quenching the part.

20. An apparatus according to claim 19, comprising an outer cylindrical aluminum water-cooled chamber;
a single magnetron coupled with a waveguide to feed energy to the chamber;
a three-stub tuner to match the impedance of the magnetron to the plasma;
an isolator to protect the magnetron by transferring the reflected microwave power to the water load; and
a mode stirrer inside the aluminum chamber to make the microwave field uniform in the chamber.
